(19) United States
(12) Patent Application Publication
(10) Pub. No.: US 2026/0292797 A1
(43) Pub. Date: Sep. 24, 2026

(54) SYSTEMS AND METHODS FOR FEEDBACK INFORMATION TRANSMISSION

(71) Applicant: ZTE CORPORATION, Shenzhen, Guangdong (CN)

(72) Inventors: Xing LIU, Shenzhen (CN); Xianghui HAN, Shenzhen (CN); Wei GOU, Shenzhen (CN); Min REN, Shenzhen (CN)

(21) Appl. No.: 19/480,175

(22) PCT Filed: May 11, 2023
(86) PCT No.: PCT/CN2023/093675

§ 371 Date: Oct. 30, 2025

(51) Int. Cl. H04W 72/0446; H04W 72/1263

(52) U.S. Cl. CPC H04W 72/0446; H04W 72/1263

(57) ABSTRACT

The present disclosure relates to systems, apparatuses, non-transitory computer-readable media, and methods for determining, by a wireless communication device, a time-domain resource of a first resource for transmitting or receiving first data overlaps with a time-domain resource of a second resource scheduled for transmitting or receiving second data and transmitting or receiving, by the wireless communication device to or from a network, both the first data and the second data.

### CROSS-REFERENCE TO RELATED APPLICATION(S)

This application is a national phase entry under 35 USC 371 of International Patent Application No. PCT/CN2023/093675 filed on May 11, 2023, and the entire content of the International Patent Application is incorporated into this application by reference.

### TECHNICAL FIELD

The disclosure relates generally to wireless communications and, more particularly, to Hybrid Automatic Repeat Requests (HARQ).

### BACKGROUND

Current mobile networks can provide users with almost ubiquitous radio access to data transmission services. As users continue to demand increasingly higher data rates, different techniques have been developed to increase the data rate and reliability of data transmissions between the network and individual user equipment (UE). In some implementations, a same UE can support different types of services, including a service that requires a high data transmission rate and a service that requires ultra-high transmission reliability and ultra-low latency.

Services of different types can be transmitted and received concurrently by a UE. For example, a UE first schedules a first service with a high data rate transmission requirement, and most resources are occupied by the first service to complete related transmission and reception. While handling the first service, a transmission requirement of another service arrives at the same UE. The second service has a low latency and high reliability requirement, requiring the network to allocate resource for the second service as soon as possible. In this scenario, the first and second services have a concurrent requirement.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

The arrangements disclosed herein relate to systems, apparatuses, non-transitory computer-readable media, and methods for determining, by a wireless communication device, a time-domain resource of a first resource for transmitting or receiving first data overlaps with a time-domain resource of a second resource scheduled for transmitting or receiving second data and transmitting or receiving, by the wireless communication device to or from a network, both the first data and the second data.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example wireless communication system, according to some arrangements.

FIG. 2 illustrates block diagrams of an example base station and an example UE device, according to some arrangements.

FIG. 3 is a diagram illustrating an example wireless communication method for communicating data, according to various arrangements.

FIG. 4 is a diagram illustrating an example wireless communication method for communicating data, according to various arrangements.

FIG. 5 is a flowchart diagram illustrating an example wireless communication method for communication data, according to various arrangements.

FIG. 6 is a diagram illustrating an example wireless communication method for communicating data, according to various arrangements.

FIG. 7 is a diagram illustrating an example wireless communication method for communicating data, according to various arrangements.

FIG. 8 is a diagram illustrating an example wireless communication method for communicating data, according to various arrangements.

FIG. 9 is a diagram illustrating an example wireless communication method for communicating data, according to various arrangements.

FIG. 10 is a diagram illustrating an example wireless communication method for communicating data, according to various arrangements.

FIG. 11 is a diagram illustrating an example wireless communication method for communicating data, according to various arrangements.

FIG. 12 is a diagram illustrating an example wireless communication method for communicating data, according to various arrangements.

FIG. 13 is a diagram illustrating an example wireless communication method for communicating data, according to various arrangements.

FIG. 14 is a diagram illustrating an example wireless communication method for communicating data, according to various arrangements.

FIG. 15 is a diagram illustrating SLIV groups for candidate time-domain resources, according to various arrangements.

FIG. 16 is a diagram illustrating SPSs, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

The arrangements disclosed herein relate to systems, apparatuses, methods, and non-transitory computer-readable media for supporting parallel transmissions or receptions of different types of services with concurrent requirements.

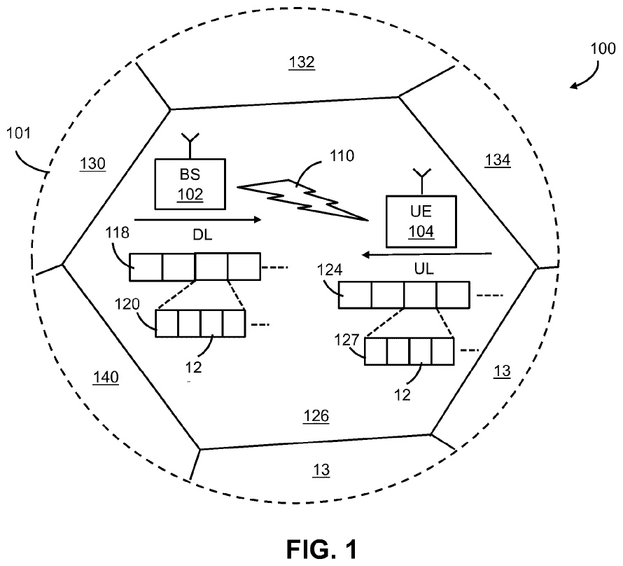

FIG. 1 illustrates an example wireless communication system 100 in which techniques disclosed herein may be implemented, in accordance with an implementation of the present disclosure. In the following discussion, the wireless communication system 100 can implement any wireless network, such as a cellular network or a narrowband Internet of things (NB-loT) network, and is herein referred to as system 100. Such an example system 100 includes a base station (BS) 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are located within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a DL radio frame 118, and an uplink (UL) radio frame 124 respectively. That is, the BS 102 can transmit data, messages, signals, and information to the UE 104 using the DL radio frame 118, and the UE 104 can transmit data, messages, signals, and information to the BS 102 using the UL radio frame 124 Each radio frame 118 or 124 can be further divided into a sub-frame 120 or 127. Each sub-frame can include one or more slots. Each sub-frame or slot can include one or more data symbols 122 or 128. In the present disclosure, the BS 102 and UE 104 are described herein as non-limiting examples of communication nodes, which can generally practice the methods disclosed herein. Such communication nodes may be capable of wireless communications, in accordance with various implementations of the present solution. In some implementations, the wireless communication system 100 may support MIMO communication. For example, MIMO is a key technology in NR systems. MIMO may be functional in both Frequency Division Duplex (FDD) and Time Division Duplex (TDD) systems, among others.

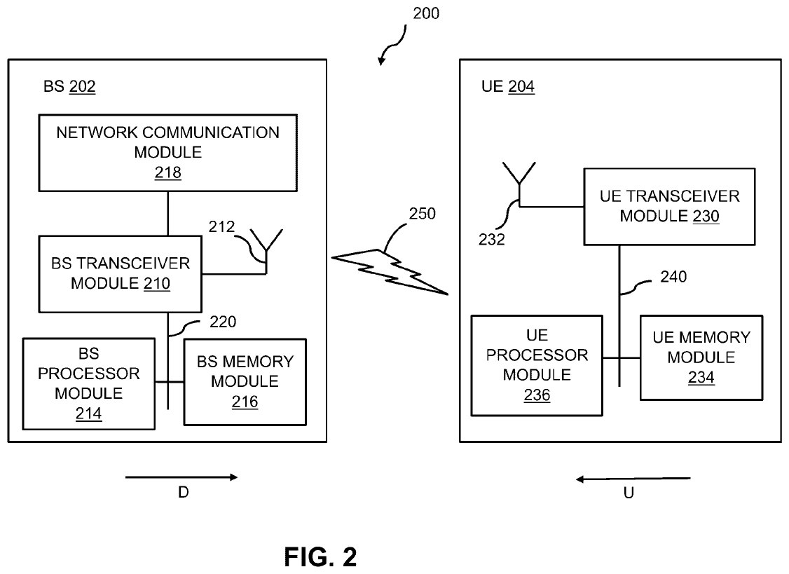

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication system 100 of FIG. 1, as described above.

System 200 generally includes a BS 202 and a UE 204. The BS 202 is an example of the BS 102. The UE 204 is an example of the UE 104. The BS 202 includes a BS transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as a UL transceiver 230 that includes a Radio Frequency (RF) transmitter and a RF receiver each including circuitry that is coupled to the antenna 232. A duplex switch (not shown) may alternatively couple the UL transmitter or receiver to the UL antenna in time duplex fashion. Similarly, in accordance with some implementations, the BS transceiver 210 may be referred to herein as a downlink (DL) transceiver 210 that includes a RF transmitter and a RF receiver each including circuity that is coupled to the antenna 212. A DL duplex switch may alternatively couple the DL transmitter or receiver to the DL antenna 212 in time duplex fashion. The operations of the two transceiver modules 210 and 230 can be coordinated in time such that the UL receiver circuitry is coupled to the UL antenna 232 for reception of transmissions over the wireless transmission link 250 at the same time that the DL transmitter is coupled to the DL antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna 212/232 arrangement that can support a particular wireless communication protocol and modulation scheme. In some illustrative implementations, the UE transceiver 230 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), gNB, a serving eNB, a target eNB, a femto station, a Transmission and Reception Point (TRP), a pico station, or another UE, for example. In some implementations, the UE 204 can be various types of user devices such as a mobile phone, a smart phone, a Personal Digital Assistant (PDA), tablet, laptop computer, wearable computing device, a terminal, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 214 and 236, respectively, such that the processors modules 214 and 236 can read information from, and write information to, memory modules 216 and 234, respectively. The memory modules 216 and 234 may also be integrated into their respective processor modules 214 and 236. In some implementations, the memory modules 216 and 234 may each include a cache memory for storing temporary variables or other intermediate information during execution of instructions to be executed by processor modules 214 and 236, respectively. Memory modules 216 and 234 may also each include non-volatile memory for storing instructions to be executed by the processor modules 214 and 236, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

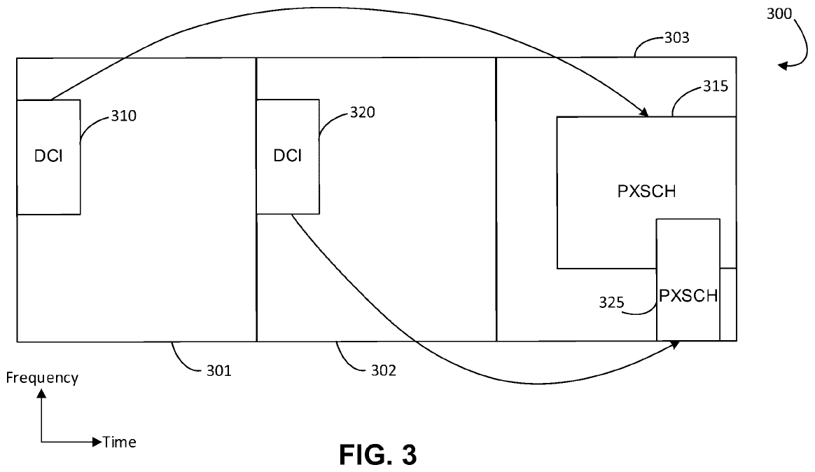

FIG. 3 is a diagram illustrating an example wireless communication method 300 for communicating data, according to various arrangements. The method 300 can be implemented using the systems 100 and/or 200. The horizontal or x-axis denotes the time-domain and time-domain resources (e.g., frames, subframes, slots, symbols, and so on). The vertical or y-axis denotes the frequency domain and frequency-domain resources (e.g., frequency ranges, Bandwidth Part (BWP), Resource Blocks (RBs), and so on). In the frame structure shown in FIG. 3, three time-domain resources (e.g., slots) 301, 302, and 303 are shown. Each of Downlink Control Information (DCI) 310 or 320 can be a UL DCI that schedules UL transmission or a DL DCI that schedules a DL transmission. As used herein, each PXSCH 315 or 325 can refer to a Physical Downlink Shared Channel (PDSCH) or a Physical Uplink Shared Channel (PUSCH), depending on whether the DCI 310 or 320 is an UL or DL DCI. The DCI 310 schedules the PXSCH 315, and the DCI 320 schedules the PXSCH 325.

In the example in which the DCIs 310 and 320 are DL DCIs and the PXSCHs 315 and 325 are PDSCHs, the BS 102 can transmit the DCI 310 to the UE 104. The UE 104 detects the DCI 310 in the slot 301. The DCI 310 schedules a PXSCH 315, which is to be transmitted by the BS 102 or received by the UE 104 in the slot 303. After the DCI 310 is transmitted, the BS 102 schedules another DL transmission (e.g., carried in PXSCH 325) with a higher priority for the slot 303 as soon as possible, e.g., for the slot 303. Without regard for PXSCH 315, the BS 102 transmits to the UE 104 the DL DCI 320 that schedules the PXSCH 325, and the UE 104 would detect the DL DCI 320 in the slot 302. As the time-frequency domain resource for the PXSCH 325 has been allocated for PXSCH 315, the DL transmission with higher priority (e.g., carried in PXSCH 325) cannot be scheduled by the BS 102 to overlap with PXSCH 315 or Frequency-Domain Multiplexing (FDM) with PXSCH 315. In other words, presently, the UE 104 cannot receive two PXSCHs 315 and 325 that are FDMed with each other. In addition, PXSCH 315 also cannot be canceled by another DL transmission with higher priority such as PXSCH 325. Therefore, PXSCH 325 is conventionally scheduled for the subsequent available resource (e.g., a slot after the slot 303), which increases the transmission delay of PXSCH 325 and is unacceptable for the transmission of a low-delay service.

Similar issues likewise exist between two UL transmissions PUSCHs that the UE 104 schedules to transmit to the BS 102. Each of the UL transmissions is carried on PXSCH 315 or 325 that is a PUSCH, and the DCI 310 and 320 are UL DCIs.

Some arrangements disclosed herein support parallel transmission of different types of services for the UE 104. For example, the UE 104 can be configured to support FDMed reception or transmission of two or more PXSCHs (e.g., two or more PDSCHs or PUSCHs).

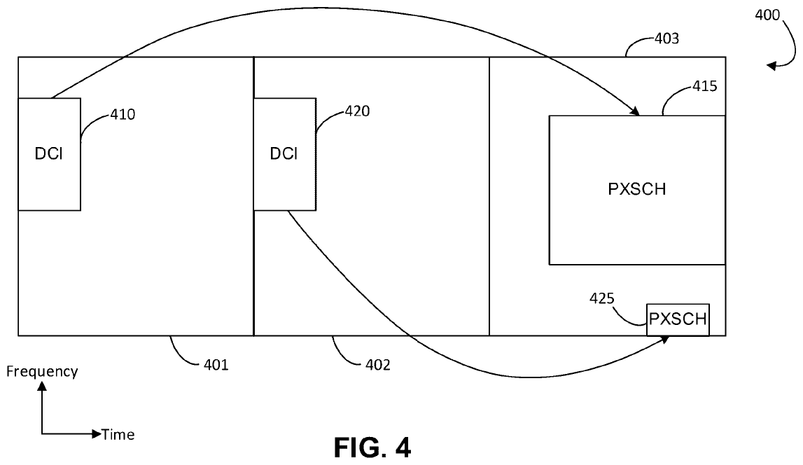

FIG. 4 is a diagram illustrating an example wireless communication method 400 for communicating data, according to various arrangements. The method 400 can be implemented using the systems 100 and/or 200. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). In the frame structure shown in FIG. 4, three time-domain resources (e.g., slots) 401, 402, and 403 are shown. Each of DCI 410 or 420 can be a UL DCI that schedules UL transmission or a DL DCI that schedules a DL transmission. PXSCHs 415 and 425 can be PDSCHs or PUSCHs, depending on whether the DCIs 410 or 420 are UL or DL DCIs.

The DCI 410 schedules the PXSCH 415, and the DCI 420 schedules the PXSCH 425. In some arrangements, the PXSCH 415 and 425 are FDMed with each other. As shown, resources for PXSCH 415 and 425 overlap in the time domain and do not overlap in the frequency domain. The UE 104 can transmit or receive PXSCH 415 and 425 simultaneously.

In some examples, the intra-UE preemption, cancellation, and/or multiplexing rule can be defined to allow subsequently scheduled PXSCH (or post-scheduled PXSCH) to preempt or cancel the previously scheduled PXSCH. In some examples, the subsequently scheduled PXSCH can be scheduled to overlap with the previously scheduled PXSCH, and the previously scheduled PXSCH is transmitted or received with rate matching or puncturing or cancelation according to the overlapped resource between the PXSCHs. In some examples, some resource (e.g., an overlapped resource between PXSCHs) may not be available for transmitting or receiving one PXSCH (e.g., PXSCH which is previously scheduled) of those overlapped PXSCHs. One of rate matching, puncturing, or cancelation can be used for transmitting or receiving the previously scheduled PXSCH. Regarding rate matching, data is encoded and mapped to a physical resource according to the available resource. The data is also decoded by the receiver according to the available resource. Regarding puncturing, the data is encoded according to the resource scheduled for the PXSCH (including both of available resource and unavailable resource), and the data is not mapped on the unavailable resource. In other words, the data mapping to the unavailable resource will be dropped. The receiver decodes the data according to the scheduled resource (including both of available resource and unavailable resource). Regarding cancelation, the data is encoded according to the resource scheduled for the PXSCH (including both of available resource and unavailable resource), and the mapping to the unavailable resource is canceled. The receiver decodes the data according to the scheduled resource (including both of available resource and unavailable resource) or according to the non-canceled resource. A previously scheduled PXSCH is the PXSCH (e.g., PXSCHs 315 and 415) having a DCI (e.g., DCI 310 and 410) that is received by the UE 104 or transmitted by the BS 102 before a DCI (e.g., 320 and 420) that schedules the subsequently scheduled PXSCH (e.g., PXSCHs 325 and 425) is received by the UE 104 or transmitted by the BS 102.

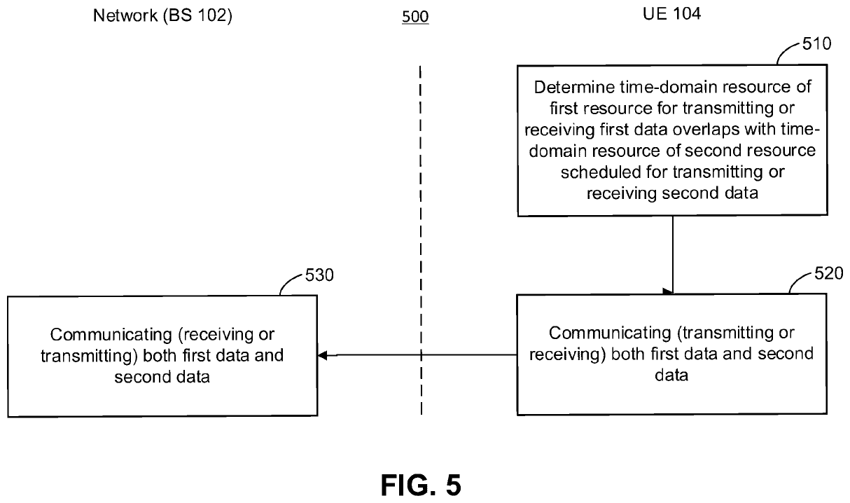

FIG. 5 is a flowchart diagram illustrating an example wireless communication method 500 for communication data, according to various arrangements. The method 500 can be implemented using the systems 100 and/or 200.

At 510, the UE 104 determines a time-domain resource of a first resource (e.g., for the previously scheduled PXSCH) for communicating (e.g., transmitting or receiving) first data overlaps with a time-domain resource of a second resource (e.g., for the subsequently scheduled PXSCH) scheduled for transmitting or receiving second data.

In some examples, the first data includes or is carried in at least one of a PXSCH, a first PUSCH, a first dynamically scheduled PUSCH, a first configured grant PUSCH, a first PDSCH, a first dynamically scheduled PDSCH, or a first Semi-Persistent Scheduling (SPS) PDSCH. In some examples, the second data includes or is carried in at least one of a PXSCH, a second PUSCH, a second dynamically scheduled PUSCH, a second configured grant PUSCH, a second PDSCH, a second dynamically scheduled PDSCH, or a second SPS PDSCH. The first data is scheduled or configured before the second data. The DCI that schedules the first data is transmitted by the network (e.g., the BS 102) or received by the UE 104 before the DCI that schedules the second data is transmitted by the BS 102 or received by the UE 104.

At 520 and 530, the UE 104 communicates both the first and second data with the BS 102 in parallel. For example, the UE 104 can transmit PUSCHs for the first and second data to the BS 102 in UL in parallel at 520, and the BS 102 receives the PUSCHs in parallel at 530. For example, the BS 102 can transmit PDSCHs for the first and second data to the UE 104 in DL in parallel at 530, and the UE 104 receives the PDSCHs in parallel at 520.

In some arrangements, rate matching or puncturing resource can be defined for an unavailable resource of the previously scheduled PXSCH.

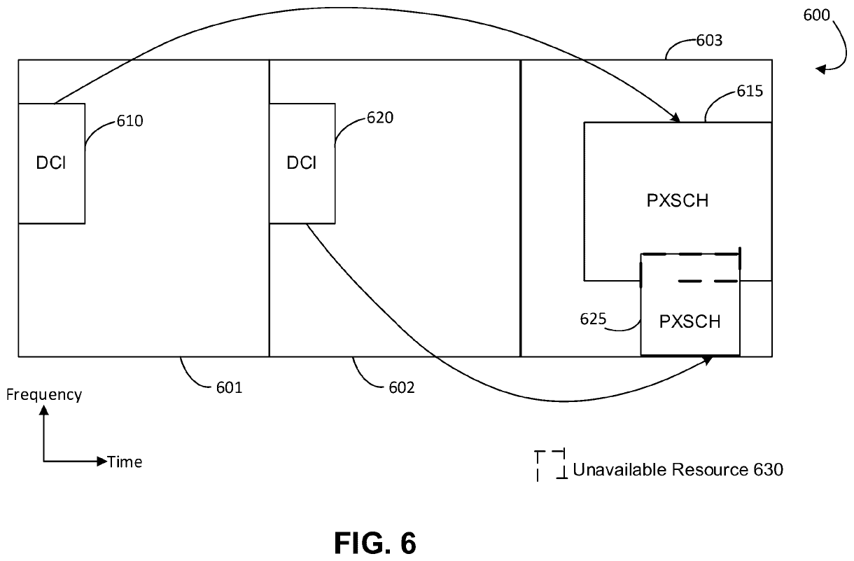

FIG. 6 defines one type of unavailable resource. FIG. 6 is a diagram illustrating an example wireless communication method 600 for communicating data, according to various arrangements. The method 600 can be implemented using the systems 100 and/or 200. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). In the frame structure shown in FIG. 6, three time-domain resources (e.g., slots) 601, 602, and 603 are shown. Each of DCI 610 or 620 can be a UL DCI that schedules UL transmission or a DL DCI that schedules a DL transmission. PXSCHs 615 and 625 can be PDSCHs or PUSCHs, depending on whether the DCIs 610 or 620 are UL or DL DCIs. The DCI 610 schedules the PXSCH 615, and the DCI 620 schedules the PXSCH 625.

As shown in FIG. 6, an overlapping part or portion between resources used for different PXSCHs 615 and 625 for the same UE 104 is defined as an unavailable resource 630 of the previously scheduled PXSCH 615 (e.g., for the first data or the first resource). That is, the overlapped part is the same as the unavailable resource 630. In some examples, the method 500 further includes determining that at least a portion of the first resource (e.g., the resource for the PXSCH 615) is an unavailable resource (e.g., the unavailable resource 630). The unavailable resource is unavailable for the transmission of the first data, e.g., for the PXSCH 615. In some examples, the method 500 further includes determining that the at least a portion of the first resource (e.g., the resource for the PXSCH 615) is an unavailable resource (e.g., the unavailable resource 630), in response to determining that the at least a portion of the first resource has a time-domain resource that overlaps with a time-domain resource of the second resource (e.g., the resource for the PXSCH 625) and a frequency-domain resource that overlaps with a frequency-domain resource of the second resource.

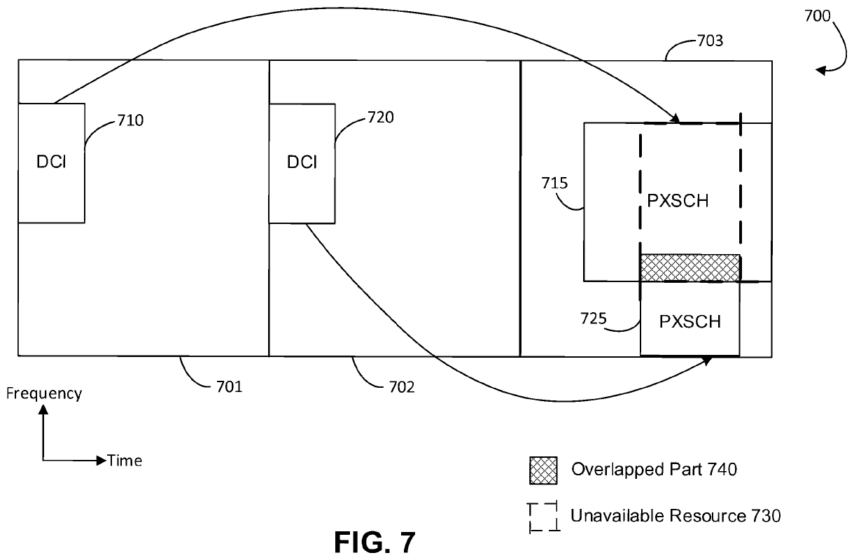

FIG. 7 defines one type of unavailable resource. FIG. 7 is a diagram illustrating an example wireless communication method 700 for communicating data, according to various arrangements. The method 700 can be implemented using the systems 100 and/or 200. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). In the frame structure shown in FIG. 7, three time-domain resources (e.g., slots) 701, 702, and 703 are shown. Each of DCI 710 or 720 can be a UL DCI that schedules UL transmission or a DL DCI that schedules a DL transmission. PXSCHs 715 and 725 can be PDSCHs or PUSCHs, depending on whether the DCIs 710 or 720 are UL or DL DCIs. The DCI 710 schedules the PXSCH 715, and the DCI 720 schedules the PXSCH 725.

As shown in FIG. 7, resources for different PXSCHs 715 and 725 for the same UE 104 overlap at an overlapping part or portion 740. The unavailable resource 730 of the previously scheduled PXSCH 715 is or includes the time-domain resources (e.g., symbols) where the overlapping part 740 is located. In some examples, the method 500 further includes determining that the at least a portion of the first resource (e.g., the resource for the PXSCH 715) is an unavailable resource (e.g., the unavailable resource 730) in response to determining that the at least a portion of the first resource has a time-domain resource that overlaps with a time-domain resource (e.g., symbols) of the second resource (e.g., the resource for the PXSCH 725).

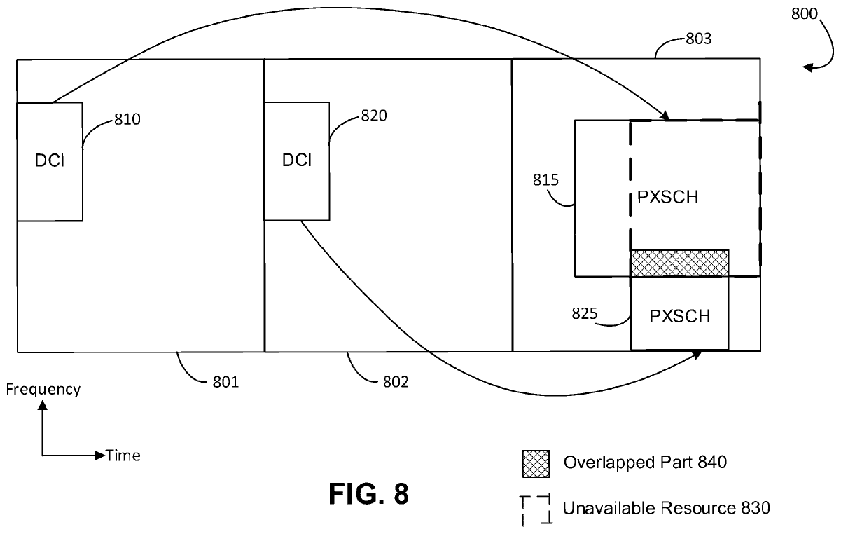

FIG. 8 defines one type of unavailable resource. FIG. 8 is a diagram illustrating an example wireless communication method 800 for communicating data, according to various arrangements. The method 800 can be implemented using the systems 100 and/or 200. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). In the frame structure shown in FIG. 8, three time-domain resources (e.g., slots) 801, 802, and 803 are shown. Each of DCI 810 or 820 can be a UL DCI that schedules UL transmission or a DL DCI that schedules a DL transmission. PXSCHs 815 and 825 can be PDSCHs or PUSCHs, depending on whether the DCIs 810 or 820 are UL or DL DCIs. The DCI 810 schedules the PXSCH 815, and the DCI 820 schedules the PXSCH 825.

As shown in FIG. 8, resources for different PXSCHs 815 and 825 for the same UE 104 overlap at an overlapping part or portion 840. The unavailable resource 830 of the previously scheduled PXSCH 815 is or includes the entire time-domain resource (e.g., symbols) of previously scheduled PXSCH 815 starting from the overlapping part 840. In some examples, the method 500 further includes determining that the at least a portion of the first resource (e.g., the resource for the PXSCH 815) is an unavailable resource (e.g., the unavailable resource 830) in response to determining that the at least a portion of the first resource (e.g., the resource for the PXSCH 715) has a first time-domain resource (e.g., symbol) that is no earlier than or later than a starting time-domain resource of the second resource (e.g., the resource for the PXSCH 825). In some examples, the method 500 further includes determining that the at least a portion of the first resource (e.g., the resource for the PXSCH 815) is an unavailable resource (e.g., the unavailable resource 830) in response to determining that the at least a portion of the first resource (e.g., the resource for the PXSCH 715) has a second time-domain resource that overlaps with a time-domain resource of the second resource and a third time-domain resource that is no earlier than or later than a last time-domain resource of the second resource.

In some arrangements, there is no overlap between different PXSCHs that are FDMed with each other. The previously scheduled PXSCH can be transmitted with a rate matching or puncturing.

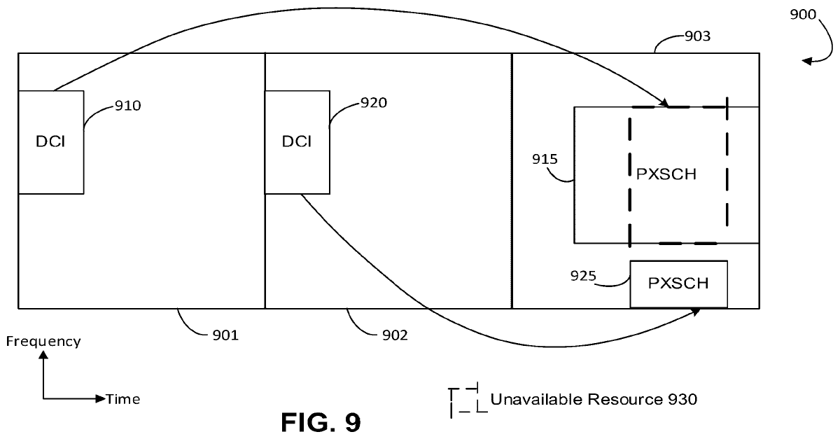

FIG. 9 defines one type of unavailable resource. FIG. 9 is a diagram illustrating an example wireless communication method 900 for communicating data, according to various arrangements. The method 900 can be implemented using the systems 100 and/or 200. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). In the frame structure shown in FIG. 9, three time-domain resources (e.g., slots) 901, 902, and 903 are shown. Each of DCI 910 or 920 can be a UL DCI that schedules UL transmission or a DL DCI that schedules a DL transmission. PXSCHs 915 and 925 can be PDSCHs or PUSCHs, depending on whether the DCIs 910 or 920 are UL or DL DCIs. The DCI 910 schedules the PXSCH 915, and the DCI 920 schedules the PXSCH 925.

As shown in FIG. 9, resources for different PXSCHs 915 and 925 for the same UE 104 may not overlap. The unavailable resource 930 of the previously scheduled PXSCH 915 can be defined as time-domain resources (e.g., symbols) that are occupied by the post-scheduled PXSCH 925. In some examples, the method 500 further includes determining that the at least a portion of the first resource (e.g., the resource for the PXSCH 915) is an unavailable resource (e.g., the unavailable resource 930) in response to determining that the at least a portion of the first resource has a time-domain resource that overlaps with a time-domain resource (e.g., symbols) of the second resource (e.g., the resource for the PXSCH 925).

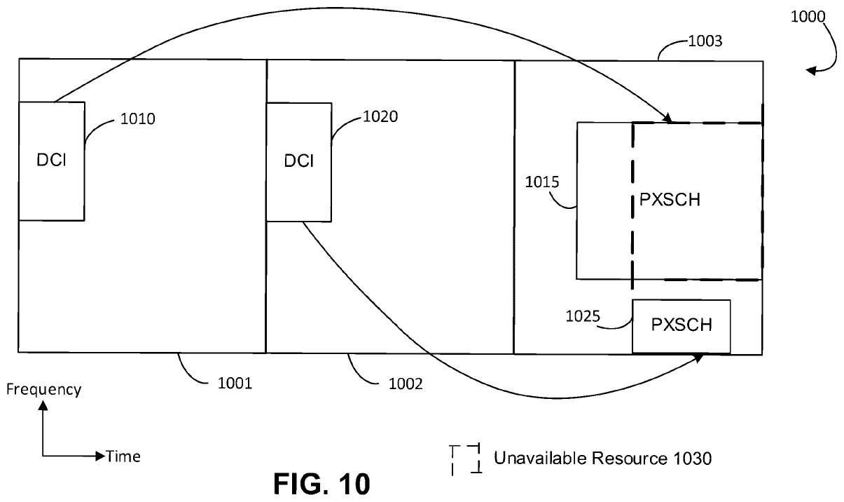

FIG. 10 defines one type of unavailable resource. FIG. 10 is a diagram illustrating an example wireless communication method 1000 for communicating data, according to various arrangements. The method 1000 can be implemented using the systems 100 and/or 200. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). In the frame structure shown in FIG. 10, three time-domain resources (e.g., slots) 1001, 1002, and 1003 are shown. Each of DCI 1010 or 1020 can be a UL DCI that schedules UL transmission or a DL DCI that schedules a DL transmission. PXSCHs 1015 and 1025 can be PDSCHs or PUSCHs, depending on whether the DCIs 1010 or 1020 are UL or DL DCIs. The DCI 1010 schedules the PXSCH 1015, and the DCI 1020 schedules the PXSCH 1025.

As shown in FIG. 10, resources for different PXSCHs 1015 and 1025 for the same UE 104 may not overlap. The unavailable resource 1030 of the previously scheduled PXSCH 1015 is or includes the entire time-domain resource (e.g., symbols) of the PXSCH 1015 starting from the beginning of the post-scheduled PXSCH 1025. In some examples, the method 500 further includes determining that the at least a portion of the first resource (e.g., the resource for the PXSCH 1015) is an unavailable resource (e.g., the unavailable resource 1030) in response to determining that the at least a portion of the first resource (e.g., the resource for the PXSCH 1015) has a first time-domain resource (e.g., symbol) that is no earlier than or later than a starting time-domain resource of the second resource (e.g., the resource for the PXSCH 1025). In some examples, the method 500 further includes determining that the at least a portion of the first resource (e.g., the resource for the PXSCH 1015) is an unavailable resource (e.g., the unavailable resource 1030) in response to determining that the at least a portion of the first resource (e.g., the resource for the PXSCH 1015) has a second time-domain resource that overlaps with a time-domain resource of the second resource and a third time-domain resource that is no earlier than or later than a last time-domain resource of the second resource.

In some arrangements, the method 500 further includes the UE 104 multiplexing the second data on the first resource. For example, the post-scheduled PXSCH can be multiplexed on the previously scheduled PXSCH according to predefined rule.

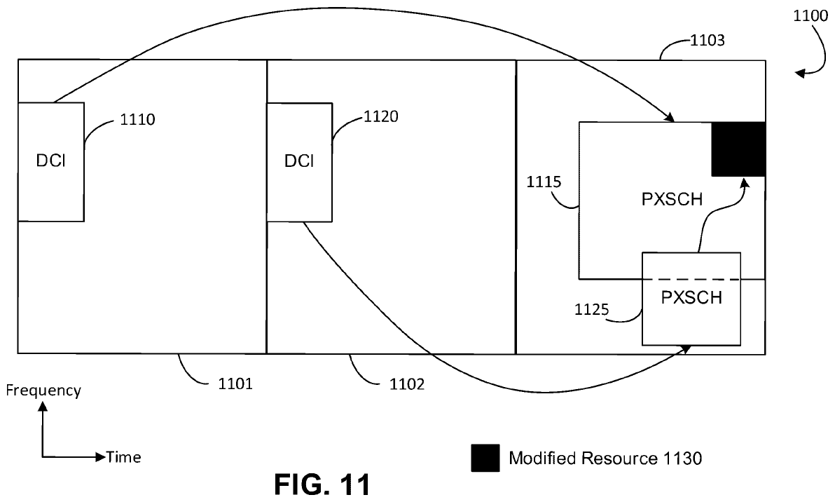

FIG. 11 is a diagram illustrating an example wireless communication method 1100 for communicating data, according to various arrangements. The method 1100 can be implemented using the systems 100 and/or 200. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). In the frame structure shown in FIG. 11, three time-domain resources (e.g., slots) 1101, 1102, and 1103 are shown. Each of DCI 1110 or 1120 can be a UL DCI that schedules UL transmission or a DL DCI that schedules a DL transmission. PXSCHs 1115 and 1125 can be PDSCHs or PUSCHs, depending on whether the DCIs 1110 or 1120 are UL or DL DCIs. The DCI 1110 schedules the PXSCH 1115, and the DCI 1120 schedules the PXSCH 1125.

As shown in FIG. 11, resources for different PXSCHs 1115 and 1125 for the same UE 104 overlap. For example, the post-scheduled PXSCH 1125 can be multiplexed on the previously scheduled PXSCH 1115 according to predefined rule. For example, the transmission resource of PXSCH 1125 (which is indicated via DCI 1120) is switched or modified to the modified resource 1130. The modified resource 1130 is the actual transmission resource that the UE 104 uses to transmit or receive PXSCH 1125. The modified resource 1130 is within the transmission resource of the previously scheduled PXSCH 1115. The modified resource 1130 for PXSCH 1125 is not available for transmitting or receiving PXSCH 1115. In other words, the PXSCH 1115 will be transmitted or received by the UE 104 or the BS 102 using rate matching or puncturing around the modified resource 1130 for PXSCH 1125. Accordingly, in the method 500, multiplexing the second data (e.g., the PXSCH 1125) on the first resource (e.g., the resource for PXSCH 1115) includes determining a third resource (e.g., the modified resource 1130) for transmitting or receiving the second data. At least a portion of the third resource is within the first resource.

In some arrangements, two or more transmission mechanisms for parallel transmissions of different types of services can be defined. The network (e.g., the BS 102) can indicate a transmission mechanism to the UE 104 via a DCI or a higher layer signaling (e.g., a Media Access Control (MAC) Control Element (CE), Radio Resource Control (RRC) signaling, and so on). In other words, the method 500 further includes transmitting by the network (e.g., the BS 102) to the UE 104 and the UE 104 receiving from the network an indication indicating one of a plurality of mechanisms for transmitting or receiving both the first data and the second data. The indication is in a DCI or a higher layer signaling. Accordingly, the UE 104 can determine its own transmitting/receiving behavior for the two transmissions to be transmitted or received in parallel.

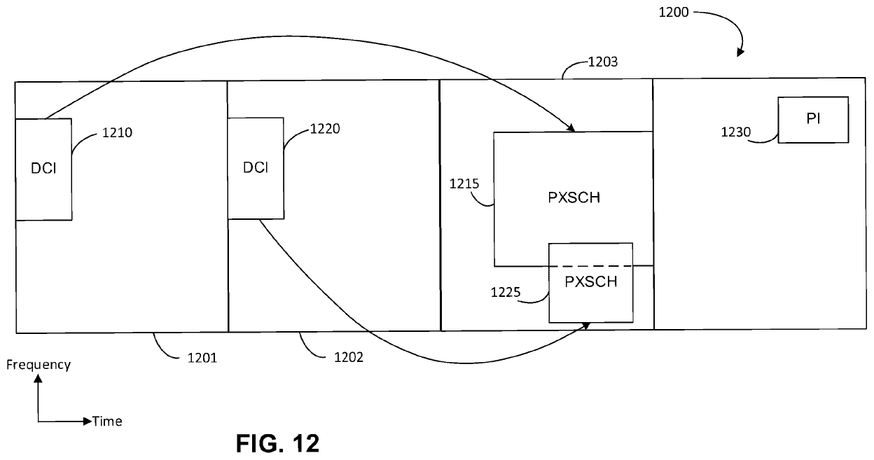

FIG. 12 is a diagram illustrating an example wireless communication method 1200 for communicating data, according to various arrangements. The method 1200 can be implemented using the systems 100 and/or 200. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). In the frame structure shown in FIG. 12, three time-domain resources (e.g., slots) 1201, 1202, and 1203 are shown. Each of DCI 1210 or 1220 can be a UL DCI that schedules UL transmission or a DL DCI that schedules a DL transmission. PXSCHs 1215 and 1225 can be PDSCHs or PUSCHs, depending on whether the DCIs 1210 or 1220 are UL or DL DCIs. The DCI 1210 schedules the PXSCH 1215, and the DCI 1220 schedules the PXSCH 1225.

As shown in FIG. 12, resources for different PXSCHs 1215 and 1225 for the same UE 104 overlap. The PXSCHs 1215 and 1225 are scheduled/configured to be transmitted or received in the overlapping resource. A DCI such as an enhanced Preemption Indication (PI) 1230 can be defined. One or more bits in the enhanced PI 1230 correspond to the UE 104 and indicate a mechanism on how to transmit or receive the PXSCHs 1215 and 1225. For example, two mechanisms for UE behaviors include rate matching and puncturing. The enhanced PI 1230 includes one bit that identifies the mechanism. For example, the enhanced PI 1230 having the value “0” indicates rate matching, and the value “1” indicates puncturing. In some arrangements, the enhanced PI 1230 can be a group common DCI, which is used for indicating transmitting/receiving mechanism/UE behavior for a plurality of UEs including the UE 104. Each UE (such as the UE 104) has at least one corresponding bit in the enhanced PI 1230 in some examples. In some examples, two or more UEs share a same indication bit in the enhanced PI 1230. In some arrangements, the method 500 further includes transmitting by the network (e.g., the BS 102) to the UE 104 and the UE 104 receiving from the network a DCI (e.g., a group-common DCI or the enhanced PI 1230) indicating a mechanism for transmitting or receiving data to a plurality of UEs. Each of the plurality of UEs corresponds to a bit in the DCI in some examples. In some examples, two or more of the plurality of UE corresponds to a bit in the DCI.

In some arrangements, the indication bit can be in the scheduling DCI (e.g., the DCI 1220), which schedules the post-scheduled PXSCH 1225. In some arrangements, the method 500 further includes transmitting by the network (e.g., the BS 102) to the UE 104 and the UE 104 receiving from the network a DCI indicating one of a plurality of mechanisms for transmitting or receiving both the first data (e.g., the PXSCH 1215) and the second data (e.g., the PXSCH 1225). The DCI schedules the second resource (e.g., for the PXSCH 1225).

In some arrangements, the indication bit can be in the DCI 1210, which schedules the previously scheduled PXSCH 1215. In some arrangements, the indication can be omitted by the UE 104 in response to determining that the indication is in the DCI that schedules the previously scheduled PXSCH 1215. In some arrangements, the method 500 further includes transmitting by the network (e.g., the BS 102) to the UE 104 and the UE 104 receiving from the network a DCI indicating one of a plurality of mechanisms for transmitting or receiving both the first data (e.g., the PXSCH 1215) and the second data (e.g., the PXSCH 1225). The DCI schedules the first resource (e.g., for the PXSCH 1215). The UE 104 ignores or omits such indication.

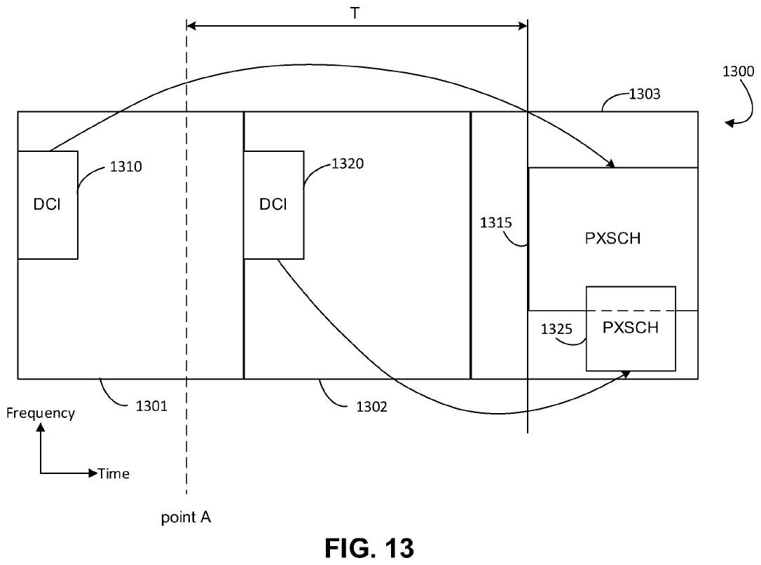

FIG. 13 is a diagram illustrating an example wireless communication method 1300 for communicating data, according to various arrangements. The method 1300 can be implemented using the systems 100 and/or 200. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). In the frame structure shown in FIG. 13, three time-domain resources (e.g., slots) 1301, 1302, and 1303 are shown. Each of DCI 1310 or 1320 can be a UL DCI that schedules UL transmission or a DL DCI that schedules a DL transmission. PXSCHs 1315 and 1325 can be PDSCHs or PUSCHs, depending on whether the DCIs 1310 or 1320 are UL or DL DCIs. The DCI 1310 schedules the PXSCH 1315, and the DCI 1320 schedules the PXSCH 1325.

As shown in FIG. 13, resources for different PXSCHs 1315 and 1325 for the same UE 104 overlap. The PXSCHs 1315 and 1325 are scheduled/configured to be transmitted or received in the overlapping resource. In some arrangements, a time period T (e.g., timeline, time duration, time interval, and so on) is defined for distinguishing different transmitting/receiving mechanism or UE behaviors. In the example in which the last time-domain resource (e.g., symbol) of the DCI 1320 scheduling the post-scheduled PXSCH 1325 is earlier than or no later than point A, the UE 104 applies a first UE behavior (or a first transmitting/receiving mechanism) such as rate matching. In the example in which the last time-domain resource (e.g., symbol) of the DCI 1320 scheduling the post-scheduled PXSCH 1325 is no earlier than or later than point A, the UE 104 applies a second UE behavior (or a second transmitting/receiving mechanism) such as puncturing or cancelation. In some arrangements, the position of point A is determined according to the starting point of the earlier one of the PXSCH 1315 and 1325 and the value of T. In some examples, point A is determined as T before the first time-domain resource (e.g., symbol) of the earlier PXSCH 1315.

In some arrangements, the method 500 further includes determining a time threshold (e.g., A) based on a time period (e.g., T) before a starting point of an earlier one of the first resource (e.g., for PXSCH 1315) and the second resource (e.g., for PXSCH 1325). In response to determining that a last time-domain resource (e.g., symbol) of the DCI 1320 scheduling the second resource is earlier than or no later than the time threshold, the UE 104 applies a first mechanism (e.g., one of rate matching, puncturing, or cancelation) for transmitting or receiving both the first data (e.g., PXSCH 1315) and the second data (e.g., PXSCH 1325). In response to determining that a last time-domain resource (e.g., symbol) of the DCI 1320 scheduling the second resource is no earlier than or later than the time threshold, the UE 104 applies a second mechanism (e.g., another one of rate matching, puncturing, or cancelation) for transmitting or receiving both the first data and the second data.

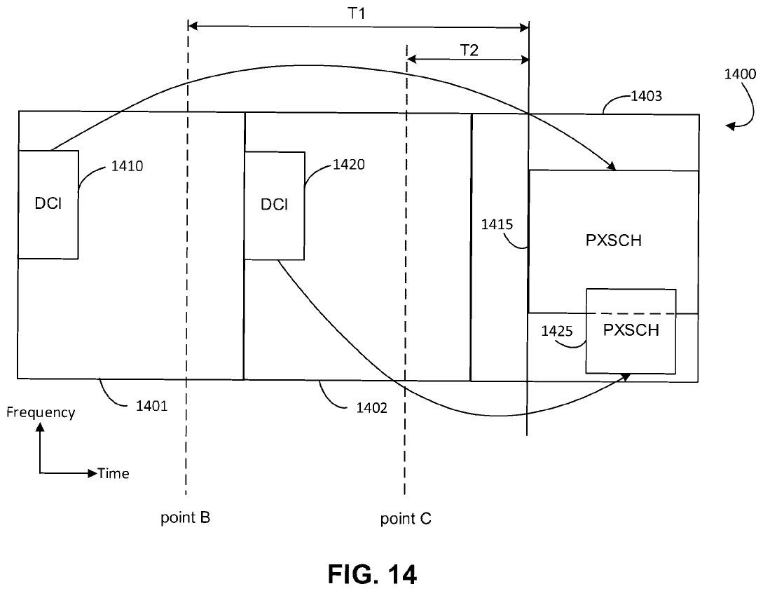

FIG. 14 is a diagram illustrating an example wireless communication method 1400 for communicating data, according to various arrangements. The method 1400 can be implemented using the systems 100 and/or 200. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). In the frame structure shown in FIG. 14, three time-domain resources (e.g., slots) 1401, 1402, and 1403 are shown. Each of DCI 1410 or 1420 can be a UL DCI that schedules UL transmission or a DL DCI that schedules a DL transmission. PXSCHs 1415 and 1425 can be PDSCHs or PUSCHs, depending on whether the DCIs 1410 or 1420 are UL or DL DCIs. The DCI 1410 schedules the PXSCH 1415, and the DCI 1420 schedules the PXSCH 1425.

As shown in FIG. 14, resources for different PXSCHs 1415 and 1425 for the same UE 104 overlap. The PXSCHs 1415 and 1425 are scheduled/configured to be transmitted or received in the overlapping resource. In some arrangements, at least two time periods T1 and T2 are defined to distinguish different transmitting/receiving mechanisms or UE behaviors. In the example in which the last time-domain resource (e.g., symbol) of the DCI 1420 scheduling the post-scheduled PXSCH 1425 is earlier than or no later than point B, the UE 104 applies a first UE behavior (or a first transmitting/receiving mechanism) such as rate matching. In the example in which the last time-domain resource (e.g., symbol) of the DCI 1420 scheduling the post-scheduled PXSCH 1425 is no earlier than or later than point B and earlier than or no later than point C, the UE 104 applies a second UE behavior (or a second transmitting/receiving mechanism) such as puncturing or cancelation. the example in which the last time-domain resource (e.g., symbol) of the DCI 1420 scheduling the post-scheduled PXSCH 1425 is no earlier than or later than point C, the post-scheduled PXSCH 1425 cannot be scheduled to the resource overlapping or FDMed with the previously scheduled PXSCH 1415. In other words, the UE 104 detects an error case in response to determining that the last symbol of the DCI 1420 scheduling the post-scheduled PXSCH 1425 is no earlier than or later than point C, and the post-scheduled PXSCH 1425 is scheduled to the resource overlapping or FDMed with the previously scheduled PXSCH 1415.

In some arrangements, the position of point B is determined according to the starting point of the earlier one of the PXSCH 1415 and 1425 and the value of T1. In some examples, point B is determined as T1 before the first time-domain resource (e.g., symbol) of the earlier PXSCH 1415. In some arrangements, the position of point C is determined according to the starting point of the earlier one of the PXSCH 1415 and 1425 and the value of T2. In some examples, point C is determined as T2 before the first time-domain resource (e.g., symbol) of the earlier PXSCH 1415.

In some arrangements, the method 500 further includes the UE 104 determining a first time threshold (e.g., B) based on a first time period (e.g., T1) before a starting point of an earlier one of the first resource (e.g., for PXSCH 1315) and the second resource (e.g., for PXSCH 1325). The UE 104 determines a second time threshold (e.g., C) based on a second time period (e.g., T2) before the starting point of the earlier one of the first resource and the second resource. The UE 104 selects based on the first time threshold and the second time threshold, a mechanism of a plurality of mechanisms for transmitting or receiving both the first data and the second data.

Some arrangements of the present disclosure allow generation of feedback such as type-1 Hybrid Automatic Repeat Request (HARQ)-Acknowledgement (ACK) feedback codebook to support parallel transmissions and reception of two or more PXSCHs.

A type-1 HARQ-ACK feedback codebook has a codebook size that depends on candidate time domain resource allocation within a configured or default time-domain resource allocation list. Each candidate time-domain resource allocation can be represented by the time-domain start point (e.g., a start symbol position/index) and a time-domain length (e.g., a number of symbols). The candidate time-domain resource allocation mapped to or indicated by a Start and Length Indicator Value (SLIV). All candidate time-domain resource allocation within the time-domain resource allocation list can be divided into different time domain resource allocation groups according to the time-domain relationship among the candidate time-domain resource allocation. A time-domain resource allocation group can also be referred to as a SLIV group.

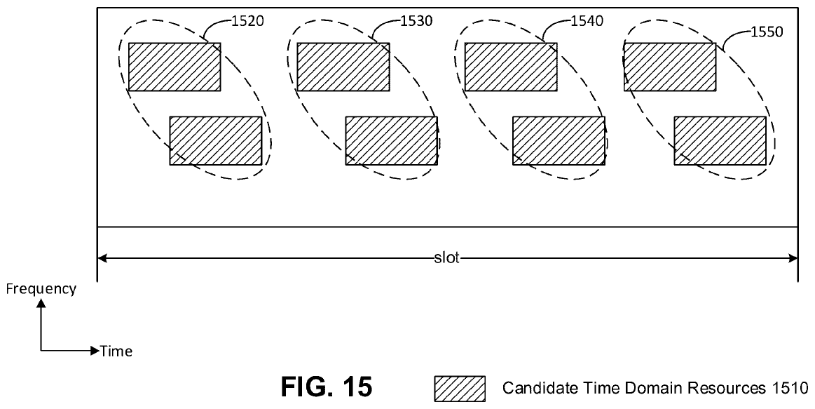

FIG. 15 is a diagram illustrating SLIV groups 1520, 1530, 1540, and 1550 for candidate time-domain resources 1510, according to various arrangements. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). In the frame structure shown in FIG. 15, a time-domain resource (e.g., a slot) is shown. The candidate time-domain resources 1510 within the slot can be grouped into four SLIV groups 1520, 1530, 1540, and 1550 as shown. That is, there are O (e.g., O=4) SLIV groups.

In the examples in which no parallel transmissions from the UE 104 is supported, there is at most one transmission for each SLIV group. In such examples, each SLIV group corresponds to 1 bit feedback information in the type-1 HARQ-ACK codebook for that UE 104 for the slot. In the examples shown in FIG. 15 in which parallel transmissions from the UE 104 is supported, there are O=4 bits in the type-1 HARQ-ACK codebook for that UE 104 for the slot.

In some arrangements in which parallel transmissions (e.g., FDM transmissions or multiplexing transmissions as described herein) from the UE 104 is supported, each SLIV group includes two or more transmissions that can be transmitted by the BS 102 to the UE 104 in DL or by the UE 104 to the BS 102 in UL. In some arrangements in which FDM transmission with at most N PDSCHs is supported, the feedback for each SLIV group includes N bits, and the feedback for a slot includes O*N bits. The value N can be a UE capability reported by the UE 104 in some examples. In some examples, the value N is configured by the network. In some examples, the value N is predefined in the specification. For example, for O=4, and N=2, the number of bits for the feedback information for the example shown in FIG. 15 is 8 per slot.

In some arrangements, at most M PDSCHs can be transmitted in a multiplexing transmissions manner per SLIV group. In some arrangements, the method 500 includes determining by the UE 104 one or more SLIV groups, and at most a first number (e.g., M) of data is received for each of the one or more SLIV groups. In other words, the PDSCH in one SLIV group can at most be multiplexed with another PDSCHs by M-1 times. There are M PDSCHs for each SLIV group. The feedback information for the SLIV group includes M bits. The feedback information for each slot includes O*M bits. The value M can be a UE capability reported by the UE 104 in some examples. In some examples, the value M is configured by the network. In some examples, the value M is predefined in the specification. For example, O=4 and M=2, and the number of bits for the feedback information for the example shown in FIG. 15 is 8 per slot.

In some arrangements, the feedback information for the FDMed or multiplexed PDSCHs in a SLIV group can be added at the end of the feedback information for the SLIV group. In some arrangements, the method 500 includes transmitting, by the UE 104 to the BS 102, first feedback information corresponding to the data in each of the one or more SLIV group. The first feedback information is added (e.g., appended or concatenated) at an end of second feedback information corresponding to each of the one or more SLIV group. The second feedback information along with the first feedback information is transmitted by the UE 104 to the BS 102. As an example in FIG. 15, the feedback information of the slot can be {x, y, x, y, x, y, x, y}, where y is the feedback information for the FDMed or multiplexed PDSCH for each of the SLIV group 1520, 1530, 1540, and 1550, and x is the feedback information for each SLIV group 1520, 1530, 1540, and 1550. That is, the feedback information of the slot can be in the format of {first feedback information for the FDMed or multiplexed PDSCH for SLIV group 1520, second feedback information for the SLIV group 1520, first feedback information for the FDMed or multiplexed PDSCH for SLIV group 1530, second feedback information for the SLIV group 1530, first feedback information for the FDMed or multiplexed PDSCH for SLIV group 1540, second feedback information for the SLIV group 1540, first feedback information for the FDMed or multiplexed PDSCH for SLIV group 1550, second feedback information for the SLIV group 1550}.

In some arrangements, the feedback information for the FDMed or multiplexed PDSCHs can be added at the end of the feedback information for the slot. In some arrangements, the method 500 includes transmitting, by the UE 104 to the BS 102, first feedback information corresponding to the data in the one or more SLIV group. The first feedback information is added (e.g., appended or concatenated) at an end of second feedback information corresponding to the one or more SLIV groups or a time-domain resource (e.g., slot). The second feedback information along with the first feedback information is transmitted by the UE 104 to the BS 102. The order of feedback information of the FDMed or multiplexed PDSCHs is determined according to a time order or sequence. As an example in FIG. 15, the feedback information of the slot can be {x, x, x, x, y1, y2, y3, y4}, wherein, y1 is the feedback information for the FDMed or multiplexed PDSCH in SLIV group 1520, y2 is the feedback information for the FDMed or multiplexed PDSCH in SLIV group 1530, y3 is the feedback information for the FDMed or multiplexed PDSCH in SLIV group 1540, and y4 is the feedback information for the FDMed or multiplexed PDSCH in SLIV group 1550, and x is the feedback information for each SLIV group 1520, 1530, 1540, and 1550. That is, the feedback information of the slot can be in the format of {first feedback information for the FDMed or multiplexed PDSCH for SLIV group 1520, first feedback information for the FDMed or multiplexed PDSCH for SLIV group 1530, first feedback information for the FDMed or multiplexed PDSCH for SLIV group 1540, first feedback information for the FDMed or multiplexed PDSCH for SLIV group 1550, second feedback information for the SLIV group 1520, second feedback information for the SLIV group 1530, second feedback information for the SLIV group 1540, and second feedback information for the SLIV group 1550}.

In some arrangements, the feedback information for the FDMed or multiplexed PDSCHs can be added at the end of the codebook. In some arrangements, the method 500 includes transmitting, by the UE 104 to the BS 102, first feedback information corresponding to the data in the one or more SLIV groups. The first feedback information is added at an end of second feedback information corresponding to a codebook. The order of feedback information of the FDMed or multiplexed PDSCHs is determined according to a time order or sequence between different SLIV groups. In an example in which the UE 104 provides to the BS 104 feedback information for PDSCHs within two slots in one codebook, and the codebook for these two slots can be {x, x, x, x, y, y, y, y, z1, z2, z3, z4, z5, z6, z7, z8}, wherein, z1, z2, z3, and z4 are the feedback information for the FDMed or multiplexed PDSCHs in SLIV groups 1, 2, 3, and 4 of the first slot, and z5, z6, z7, and z8 are the feedback information for the FDMed or multiplexed PDSCHs in SLIV groups 1, 2, 3, and 4 of the second slot.

In some arrangements, the SLIV groups are further divided into one or more SLIV group set, each SLIV group set contains one or more SLIV groups. For example, in FIG. 15 in which O=4 SLIV groups, such SLIV groups can be divided into X (e.g., X=2) SLIV group sets. A first SLIV group set includes the SLIV groups 1520 and 1530. A second SLIV group set includes the SLIV groups 1540 and 1550. In some arrangements, the one or more SLIV groups includes one or more SLIV group sets, each of the one or more SLIV group sets includes at least one SLIV group. At most an additional data is received for each of the one or more SLIV group sets in addition to one data for each of the at least one SLIV groups. The method 500 further includes transmitting, by the UE 104 to the network (e.g., the BS 102), feedback information for each of the one or more SLIV group sets, the feedback information including one bit for the additional data.

In some arrangements, at most P PDSCHs can be transmitted by the BS 102 to the UE 104 per SLIV group set in addition to one PDSCH per SLIV group. P bits feedback information are additionally needed for each SLIV group set. In some arrangements, the one or more SLIV groups includes one or more SLIV group sets, each of the one or more SLIV group sets includes at least one SLIV group. At most a third number (e.g., P) of data is received for each of the one or more SLIV group sets. The method 500 further includes transmitting, by the UE 104 to the network (e.g., the BS 102), feedback information for each of the one or more SLIV group sets, the feedback information including the third number of bits. In some arrangements, the UE 104 can transmit to the BS 102 X*P+O bits of feedback information for each slot. The value X and/or P can be a UE capability reported by the UE 104 in some examples. In some examples, the value X and/or P are configured by the network. In some examples, the value X and/or P are predefined in the specification. In some examples, X=2, P=1, O=4, and the number of bits for case of FIG. 15 is 6 per slot.

In FIGS. 15, O=4 SLIV groups are divided into X (X=2) SLIV group sets. At most Q PDSCHs can be additionally transmitted in a multiplexing transmission per SLIV group set. Q bits feedback information is additionally need for each SLIV group set. There are a total of (X*Q+O) PDSCHs in each slot. There are X*Q+O bits of feedback information for each slot. The value X and/or Q can be a UE capability reported by the UE 104 in some examples. In some examples, the value X and/or Q are configured by the network. In some examples, the value X and/or Q are predefined in the specification. In some examples, X=2, Q=1, O=4, and the number of bits for case of FIG. 15 is 6 per slot.

In some arrangements, the feedback information for the FDMed or multiplexed PDSCH in a SLIV group set can be added to the end of the feedback information for the SLIV group set. In some examples, the one or more SLIV groups includes one or more SLIV group sets, each of the one or more SLIV group sets includes multiplexed data. Multiplexed data refers to data (e.g., carried on PXSCH) scheduled to be transmitted or received in resources that overlap with other data in the time domain, where such data needs to be transmitted or received in parallel. The method 500 further includes transmitting, by the UE 104 to the network (e.g., the BS 102), first feedback information corresponding to the multiplexed data in each of the one or more SLIV group sets. The first feedback information is added (e.g., appended, concatenated, and so on) at an end of second feedback information corresponding to each of the one or more SLIV group sets. For example, in FIG. 15, the feedback information of the slot can be {x, x, y, x, x, y}, wherein, y is the feedback information for the FDMed or multiplexed PDSCHs in a SLIV group set, and x, x is the feedback information for SLIV groups in a SLIV group set, where x represents feedback information for a SLIV group. That is, the feedback information of the slot can be in the format of {second feedback information for the SLIV group 1520, second feedback information for the SLIV group 1530, first feedback information for the FDMed or multiplexed PDSCHs in a SLIV group set that includes SLIV groups 1520 and 1530, second feedback information for the SLIV group 1540, second feedback information for the SLIV group 1550, first feedback information for the FDMed or multiplexed PDSCHs in a SLIV group set that includes SLIV groups 1530 and 1540}.

In some arrangements, the feedback information for the FDMed or multiplexed PDSCHs can be added at the end of the feedback information for the slot. In some examples, the one or more SLIV groups includes one or more SLIV group sets, each of the one or more SLIV group sets includes multiplexed data. The method 500 further includes transmitting, by the UE to the network (e.g., the BS 102), first feedback information corresponding to the multiplexed data in the one or more SLIV group sets. The first feedback information is added (e.g., appended, concatenated, and so on) at an end of second feedback information corresponding to the one or more SLIV groups or a time-domain resource (e.g., slot). The order of feedback information of the FDMed or multiplexed PDSCHs is determined according to a time order or sequence between different SLIV group sets. In FIG. 15, the feedback information for the slot can be {x, x, x, x, y1, y2}, where y1 is the feedback information for the FDMed or multiplexed PDSCH in SLIV group set (including SLIV groups 1520 and 1530), and y2 is the feedback information for the FDMed or multiplexed PDSCH in SLIV group set (including SLIV groups 1540 and 1550). That is, the feedback information of the slot can be in the format of {second feedback information for the SLIV group 1520, second feedback information for the SLIV group 1530, second feedback information for the SLIV group 1540, second feedback information for the SLIV group 1550, first feedback information for the FDMed or multiplexed PDSCHs in a SLIV group set that includes SLIV groups 1520 and 1530, first feedback information for the FDMed or multiplexed PDSCHs in a SLIV group set that includes SLIV groups 1530 and 1540}.

In some arrangements, the feedback information for the FDMed or multiplexed PDSCHs can be added at the end of the codebook. In some examples, the one or more SLIV groups includes one or more SLIV group sets, each of the one or more SLIV group sets includes multiplexed data. The method 500 further includes transmitting, by the UE to the network (e.g., the BS 102), first feedback information corresponding to the multiplexed data in the one or more time-domain resource allocation group sets. The first feedback information is added (e.g., appended, concatenated, and so on) at an end of second feedback information corresponding to a codebook. The order of feedback information of the FDMed or multiplexed PDSCHs is determined according to a time order or sequence between different SLIV group sets. In an example in which the UE 104 provides feedback information for PDSCHs within two slots in a codebook, and the codebook for these two slots can be {x, x, x, x, y, y, y, y, z1, z2, z3, z4}, where z1 and z2 are the feedback information for the FDMed or multiplexed PDSCHs in a first SLIV group set and a second SLIV group set of the first slot respectively, and z3 and z4 are the feedback information for the FDMed or multiplexed PDSCHs in a first SLIV group set and second SLIV group set of the second slot respectively. In addition, x refers to feedback information for a respective SLIV group in the first slot, and y refers to feedback information for a respective SLIV group in the second slot.

That is, the feedback information of the codebook can be in the format of {second feedback information for a first SLIV group in the first slot, second feedback information for a second SLIV group in the first slot, second feedback information for a third SLIV group in the first slot, second feedback information for a fourth SLIV group in the first slot, second feedback information for a first SLIV group in the second slot, second feedback information for a second SLIV group in the second slot, second feedback information for a third SLIV group in the second slot, second feedback information for a fourth SLIV group in the second slot, first feedback information for the FDMed or multiplexed PDSCHs in a first SLIV group set that includes the first and second SLIV groups in the first slot, first feedback information for the FDMed or multiplexed PDSCHs in a second SLIV group set that includes the third and fourth SLIV groups in the first slot, first feedback information for the FDMed or multiplexed PDSCHs in a third SLIV group set that includes the first and second SLIV groups in the second slot, first feedback information for the FDMed or multiplexed PDSCHs in a fourth SLIV group set that includes the third and fourth SLIV groups in the second slot}.

In some arrangements, for O (e.g., O=4) SLIV groups, at most 1 PDSCH can be additionally transmitted (FDMed or multiplexed) per slot in addition to 1 PDSCH per SLIV group. 1 bit feedback information corresponding to the additional PDSCH is additionally needed for each slot. The UE 104 transmits to the BS 102 (1+O) bits of feedback information per slot. In some arrangements, the first number (e.g., M) is 1, and the method 500 further includes receiving, by the UE 104 from the network (e.g., the BS 102), a second number of multiplexed data for each time-domain resource (e.g., slot), the second number is 1. The method 500 further includes transmitting, by the UE 104 from the network (e.g., the BS 102), feedback information for the second number of multiplexed data, the feedback information comprises 1 bit.

In some arrangements, the feedback information for the FDMed or multiplexed PDSCH can be added at the end of the feedback information for the slot. As an example, the feedback information of PDSCH transmissions within one slot can be {x, x, x, x, y}, where y is the feedback information for the FDMed or multiplexed PDSCH for the slot, and x is the feedback information for each SLIV group in the slot. In some arrangements, the feedback information for the FDMed or multiplexed PDSCHs can be added at the end of the codebook. The order of feedback information of the FDMed or multiplexed PDSCHs is determined according to a time order between different slots. As an example, the UE 104 transmits to the BS 102 feedback information for PDSCHs within two slots in one codebook. The codebook for these two slots can be {x, x, x, x, y, y, y, y, z1, z2}, where z1 is the feedback information for the FDMed or multiplexed PDSCHs in the first slot, and z2 is the feedback information for the FDMed or multiplexed PDSCHs in the second slot. In addition, x refers to feedback information for a respective SLIV group in the first slot, and y refers to feedback information for a respective SLIV group in the second slot.

In some arrangements, for O (O=4) SLIV groups, at most Z PDSCHs can be additionally transmitted (FDMed or multiplexed) per slot in addition to 1 PDSCH per SLIV group. Z bits of feedback information is additionally needed for each slot. The UE 104 transmits to the BS 102 Z+O bits of feedback information per slot. The value Z can be a UE capability reported by the UE 104 in some examples. In some examples, the value Z is configured by the network. In some examples, the value Z is predefined in the specification. For example, Z=2, O=4, and the number of bits is 5 per slot. In some examples, the first number (e.g., M) is 1, and the method 500 further includes receiving, by the UE 104 from the network (e.g., the BS 102), a second number (e.g., Z) of multiplexed data for each time-domain resource (e.g., slot), wherein the second number is greater than 1. The method 500 further includes transmitting, by the UE 104 to the network (e.g., the BS 102), feedback information for the second number of multiplexed data, the feedback information includes the second number of bits.

In some arrangements, the feedback information for the FDMed or multiplexed PDSCH can be added at the end of the feedback information for the slot. The order of feedback information of the FDMed or multiplexed PDSCHs is determined according to the indication in the DCI which schedules the FDMed or multiplexed PDSCH. For example, the indication in the DCI is a Downlink Assignment Index (DAI) field. The FDMed or multiplexed PDSCHs are separately counted with normal PDSCHs. In some arrangements, the method 500 further includes receiving, by the UE 104 from the network (the BS 102), a DCI scheduling one or more of the plurality of PDSCHs that is multiplexed, the DCI includes an indication of an order of feedback information, the indication is in a DAI field. The method 500 further includes transmitting, by the UE 104 to the BS 102 according to the order, feedback information for the plurality of PDSCHs that is multiplexed and at least one normal PDSCH.

In an example in which Z=2, the feedback information of PDSCH transmissions within one slot can be {x, x, x, x, y1, y2}, where y1 is the feedback information for the first FDMed or multiplexed PDSCH in a slot (e.g., the value of DAI is 1) and y2 is the feedback information for the second FDMed or multiplexed PDSCH in the slot (e.g., the value of DAI is 2), and x is the feedback information for each SLIV group in the slot.

In some arrangements, the feedback information for the FDMed or multiplexed PDSCH can be added at the end of the codebook. The order of feedback information of the FDMed or multiplexed PDSCHs is determined according to the indication in the DCI which scheduling the FDMed or multiplexed PDSCH. For example, the indication in the DCI is a DAI field. The FDMed or multiplexed PDSCHs are separately counted with normal PDSCHs. In an example in which Z=2, the UE 104 provides to the BS 102 feedback information for PDSCH transmissions within two slot in one codebook. The feedback information can be {x, x, x, x, y, y, y, y, z1, z2, z3, z4}, where z1 is the feedback information for the first FDMed or multiplexed PDSCH in the first slot (e.g., the value of DAI is 1), z2 is the feedback information for the second FDMed or multiplexed PDSCH in the first slot (e.g., the value of DAI is 2), z3 is the feedback information for the first FDMed or multiplexed PDSCH in the second slot (e.g., the value of DAI is 3), and z4 is the feedback information for the second FDMed or multiplexed PDSCH in the second slot (e.g., the value of DAI is 4). In some examples, x is the feedback information for a respective SLIV group in the first slot, and y is the feedback information for a respective SLIV group in the second slot.

Accordingly, parallel transmissions for the UE 104 can be effectively supported. More specifically, type-1 HARQ-ACK feedback codebook used to provide feedback for parallel transmissions of two or more PDSCHs can be generated.

Some arrangements relate to dropping SPS PDSCHs. In the example in which the UE 104 supports both of FDM reception of two or more SPS PDSCHs and Time-Division Multiplexing (TDM) reception of two or more SPS PDSCHs in a slot, and two or more PDSCHs in a serving cell each without a corresponding Physical Downlink Control Channel (PDCCH) transmission are in a slot, the UE 104 selects two PDSCHs with lowest configured sps-ConfigIndex. The UE 104 determines whether or how to receive the remaining PDSCHs according to the relationship of the selected two PDSCHs. The relationship can be multiplexing mode of the selected two PDSCHs, i.e., FDM or TDM. An SPS PDSCH can be referred to as a PDSCH without a corresponding PDCCH transmission. In some embodiments, the method 500 further includes selecting, by the UE 104, two PDSCHs with lowest configured index, selecting, by the UE 104, at least one PDSCH other than the two PDSCHs according to a relationship of the two PDSCHs. The relationship includes one of FDM or TDM. The UE 104 receives from the network (e.g., the BS 102) the two PDSCHs and the at least one PDSCH.

In some arrangements in which the selected two PDSCHs are TDMed with each other, the UE 104 can further select among remaining PDSCHs for selecting other TDMed PDSCHs, until set of activated PDSCHs without corresponding PDCCH transmissions within the slot is empty or the number of selected PDSCHs equal to the number of TDMed PDSCHs in a slot supported by the UE 104.

In some arrangements in which the selected two PDSCHs are FDMed with each other the UE 104 can further select among remaining PDSCHs for selecting other FDMed PDSCHs, until set of activated PDSCHs without corresponding PDCCH transmissions within the slot is empty or the number of selected PDSCHs equal to the number of FDMed PDSCHs in a slot supported by the UE 104.

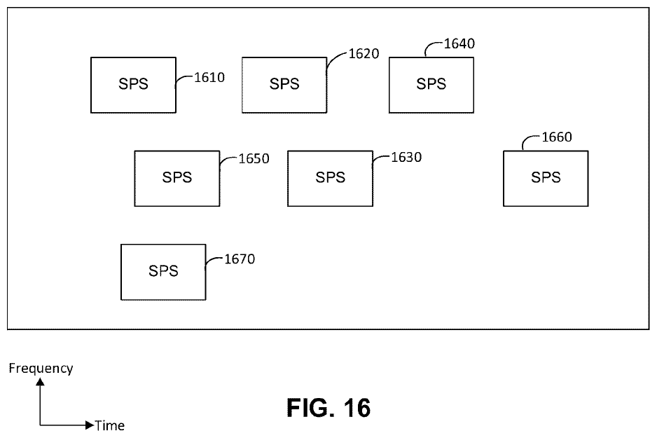

FIG. 16 is a diagram illustrating SPSs, according to various arrangements. The horizontal or x-axis denotes the time-domain and time-domain resources (e.g., frames, subframes, slots, symbols, and so on). The vertical or y-axis denotes the frequency domain and frequency-domain resources (e.g., frequency ranges, BWP, RBs, and so on). As shown in FIG. 16, SPS PDSCHs 1610, 1620, 1630, 1640, 1650, 1660, and 1670 can be received by the UE 104 from the BS 102 in various resources of a given slot.

In some examples, the UE 104 selects SPS 1610 and SPS 1620. The SPS 1610 and SPS 1620 are TDMed with each other, so other TDMed PDSCHs can be further selected from other SPSs 1630, 1640, 1650, 1660, and 1670. For example, the UE 104 supports receiving at most three SPS PDSCHs in one slot, then, the UE 104 selects SPS 1640 to be received. The SPS with lower index has higher priority. For example, SPS 1640 has higher priority as compared to SPS 1660.

In some examples, the UE 104 selects SPS 1610 and SPS 1650. The SPS 1610 and SPS 1650 are TDMed with each other, so other TDMed PDSCHs can be further selected from other SPSs 1620, 1630, 1640, 1660, and 1670. For example, the UE 104 supports receiving at most three FDMed SPS PDSCHs in one slot, then, the UE 104 selects SPS 1670 to be received. The SPS with lower index has higher priority. For example, SPS 1660 has higher priority as compared to SPS 1670.

For example, the UE 104 supports receiving at most two FDMed SPS PDSCHs in one slot, the UE 104 does not select other SPS from the remaining SPSs. In some arrangements in which the UE 104 supports receiving at most four FDMed SPS PDSCHs in one slot, after selecting SPS 1670, there is no other FDMed SPS that can be selected, and the UE 104 stops selecting another SPS PDSCH.

Accordingly, arrangements of the present disclosure effectively support parallel transmissions of different types of services for a given UE. Type-1 HARQ-ACK feedback codebook can be generated to support parallel transmissions of two or more PDSCHs. SPS PDSCHs dropping rules can be defined. The restriction on uplink/downlink scheduling is released, system transmission efficiency is improved accordingly.

In some arrangements, for a plurality of PXSCH transmissions spanning different resource types, different spatial assumptions may be made for different PXSCH transmissions on different resource types, given that interference strength on different types of resources may vary greatly. Then, taking PDSCH transmission as an example, the BS 102 can transmit a PDSCH using Tx beam #1 (e.g., Quasi-Co-Locationed (QCLed) with RS #1, such as SSB #0) if the PDSCH is located in a first type of resource. Accordingly, the UE 104 can use Rx beam #1 for receiving the PDSCH in the first type of resource. While the PDSCH is located within a second type of resource, the PDSCH transmission using Tx/Rx beam pair {Tx beam #1, Rx beam #1} may suffer serious interference. Thus, another Tx/Rx beam pair, e.g., {Tx beam #2, Rx beam #2}, can be used instead.

In some arrangements, for PDCCH transmission, more than one Transmission Configuration Indicator (TCI) states are configured by the BS 102 to the UE 104 for a Control Resource Set (CORESET) for PDCCH monitoring in different resource types. In an example in which two TCI states are configured for a CORESET, one TCI state is used for the first type of resource, and another TCI state is used for the second type of resource. In some arrangements two or more lists of TCI states are configured by the BS 102 to the UE 104 for PDSCH reception in different resource types. In an example in which two TCI state lists are configured for PDSCH reception, one TCI state is used for the first type of resource, and another TCI state is used for the second type of resource.

A TCI state used for a PDSCH transmission is indicated by the BS to the UE 104 via scheduling DCI. For a PDSCH which is scheduled to be transmitted in the first type of resource, the TCI state used for the PDSCH is indicated from the TCI state list corresponding to the first type of resource. Similarly, for a PDSCH which is scheduled to be transmitted in the second type of resource, the TCI state used for the PDSCH is indicated from the TCI state list corresponding to the second type of resource.

In some arrangements, two or more lists of SRS resource are configured by the BS 102 to the UE 104 for PUSCH reception in different resource types. In an example in which two SRS resource lists are configured for PUSCH reception, one SRS resource list is used for the first type of resource, and another SRS resource list is used for the second type of resource. Further, the SRS resource used for PUSCH transmission is indicated by the BS 102 in the UE 104 via scheduling DCI. For a PUSCH which is scheduled to be transmitted in the first type of resource, the SRS resource used for the PUSCH is indicated from the SRS resource list corresponding to the first type of resource. Similarly, for a PUSCH which is scheduled to be transmitted in the second type of resource, the SRS resource used for the PUSCH is indicated from the SRS resource list corresponding to the second type of resource.

In some arrangements, a SPS PDSCH may be located in different resource types that share a same TCI field in the DCI for activating the SPS PDSCH. In some arrangements, two or more TCI fields indicate TCI state for SPS PDSCH transmissions in different resource types. In an example with two types of resources, two TCI fields are included in the DCI for activating the SPS PDSCH. A first TCI corresponds to the first SPS PDSCH after the SPS is activated, and the resource for the first SPS PDSCH transmission can be defined as the first type of resource. A second TCI used for indicating SPS PDSCH is located in the second type of resource. In some arrangements, the first resource type is predefined, and the first TCI field corresponds to the SPS PDSCHs located within the first type of resource. The second TCI field corresponds to the SPS PDSCHs located within the second type of resource.

In some arrangements, a Configured Grant (CG) PUSCH may be located in different resource types that share a same SRS resource indicator field in the DCI for activating the CG PUSCH. In some arrangements, two or more SRS resource indicator fields indicate SRS resource for SPS PUSCH transmissions in different resource types. In an example with two types of resource, two SRS resource indicator fields are included in the DCI for activating the CG PUSCH. A first SRS resource indicator corresponds to the first CG PUSCH after the CG PUSCH is activated, and the resource for the first CG PUSCH transmission can be defined as the first type of resource. A second SRS resource indicator field used for indicating CG PUSCH located in the second type of resource. In some arrangements, the first resource type is predefined, and the first SRS resource indicator field corresponds to the CG PUSCHs located within the first type of resource. The second SRS resource indicator field corresponds to the CG PUSCHs located within the second type of resource. In some arrangements, two SRS resources are configured by the BS 102 to the UE 104 via RRC signaling for CG PUSCHs located within different resource types.

In some arrangements, different resource types can be configured by the BS 102 to the UE 104 via RRC signaling. In some arrangements, different resource types can be deduced according to TDD frame structure configuration or Subband Full Duplex (SBFD) configuration. For example, for relatively large cross-link interference and BS self-interference in an SBFD resource, a total resource may be classified into two types, e.g., SBFD resource and non-SBFD resource. In some arrangements, different TDD frame structures may be configured by the BS 102 for adjacent cells. The resource that are configured with different D/U attributes among adjacent cells can be defined as the first type of resource. The transmission within the first type of resource will suffer large cross-link interference. The remaining resource can be defined as the second type of resource.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A wireless communication method, comprising:
determining, by a wireless communication device, a time-domain resource of a first resource for transmitting or receiving first data overlaps with a time-domain resource of a second resource scheduled for transmitting or receiving second data; and
transmitting or receiving, by the wireless communication device to or from a network, both the first data and the second data.

2. The method of claim 1, wherein
the first data comprises at least one of a first Physical Uplink Shared Channel (PUSCH), a first dynamically scheduled PUSCH, a first configured grant PUSCH, a first Physical Downlink Shared Channel (PDSCH), a first dynamically scheduled PDSCH, or a first Semi-Persistent Scheduling (SPS) PDSCH;
the second data comprises at least one of a second PUSCH, a second dynamically scheduled PUSCH, a second configured grant PUSCH, a second PDSCH, a second dynamically scheduled PDSCH, or a second SPS PDSCH; and
the first data is scheduled or configured before the second data.

3. The method of claim 1, further comprises, determining that at least a portion of the first resource is an unavailable resource, wherein the unavailable resource is unavailable for the transmission of the first data.

4. The method of claim 3, wherein the determining that the at least a portion of the first resource is an unavailable resource, in response to determining that the at least a portion of the first resource has:
a time-domain resource that overlaps with a time-domain resource of the second resource; and
a frequency-domain resource that overlaps with a frequency-domain resource of the second resource; or
a time-domain resource that overlaps with a time-domain resource of the second resource.

5. (canceled)

6. The method of claim 3, wherein the determining that the at least a portion of the first resource is an unavailable resource, in response to determining that the at least a portion of the first resource has:
a first time-domain resource that no earlier than or later than a starting time-domain resource of the second resource; or
a second time-domain resource that overlaps with a time-domain resource of the second resource, and a third time-domain resource that is no earlier than or later than a last time-domain resource of the second resource.

7. The method of claim 1, further comprising multiplexing the second data on the first resource.

8. The method of claim 7, wherein multiplexing the second data on the first resource comprises determining a third resource for transmitting or receiving the second data, at least a portion of the third resource is within the first resource.

9. The method of claim 1, further comprising receiving, by the wireless communication device from the network, an indication indicating one of a plurality of mechanisms for transmitting or receiving both the first data and the second data, wherein the indication is in a Downlink Control Information (DCI) or a higher layer signaling.

10. The method of claim 1, further comprising receiving, by the wireless communication device from the network, a Downlink Control Information (DCI) indicating a mechanism for transmitting or receiving data to a plurality of wireless communication devices, wherein
each of the plurality of wireless communication devices corresponds to a bit in the DCI; or
two or more of the plurality of wireless communication devices corresponds to a bit in the DCI.

11. The method of claim 1, further comprising receiving, by the wireless communication device from the network, a Downlink Control Information (DCI) comprising an indication indicating one of a plurality of mechanisms for transmitting or receiving both the first data and the second data, wherein the DCI schedules the second resource.

12. The method of claim 1, further comprising:
receiving, by the wireless communication device from the network, a Downlink Control Information (DCI) comprising an indication indicating one of a plurality of mechanisms for transmitting or receiving both the first data and the second data, wherein the DCI schedules the first resource; and
omitting, by the wireless communication device, the indication.

13. The method of claim 1, further comprising:
determining a time threshold based on a time period before a starting point of an earlier one of the first resource and the second resource;
in response to determining that a last time-domain resource of a Downlink Control Information (DCI) scheduling the second resource is earlier than or no later than the time threshold, applying, by the wireless communication device, a first mechanism for transmitting or receiving both the first data and the second data; and
in response to determining that a last time-domain resource of a Downlink Control Information (DCI) scheduling the second resource is no earlier than or later than the time threshold, applying, by the wireless communication device, a second mechanism for transmitting or receiving both the first data and the second data.

14. The method of claim 1, further comprising:
determining a first time threshold based on a first time period before a starting point of an earlier one of the first resource and the second resource;
determining a second time threshold based on a second time period before the starting point of the earlier one of the first resource and the second resource; and
selecting, by the wireless communication device based on the first time threshold and the second time threshold, a mechanism of a plurality of mechanisms for transmitting or receiving both the first data and the second data.

15. The method of claim 1, further comprising determining one or more start and length indicator value (SLIV) groups, and at most a first number of data is received for each of the one or more SLIV groups.

16. The method of claim 15, further comprising
transmitting, by the wireless communication device to the network, first feedback information corresponding to the data in each of the one or more SLIV group, wherein the first feedback information is added at an end of second feedback information corresponding to each of the one or more SLIV group; or
transmitting, by the wireless communication device to the network, first feedback information corresponding to the data in the one or more SLIV groups, wherein the first feedback information is added at an end of second feedback information corresponding to the one or more SLIV groups or a time-domain resource; or
transmitting, by the wireless communication device to the network, first feedback information corresponding to the data in the one or more SLIV groups, wherein the first feedback information is added at an end of second feedback information corresponding to a codebook.

17-18. (canceled)

19. The method of claim 15, wherein
the one or more SLIV groups comprises one or more SLIV group sets, each of the one or more SLIV group sets comprises at least one SLIV group; and
at most an additional data is received for each of the one or more SLIV group sets in addition to one data for each of the at least one SLIV groups; and
the method further comprising transmitting, by the wireless communication device to the network, feedback information for each of the one or more SLIV group sets, the feedback information comprising one bit for the additional data; or
the one or more SLIV groups comprises one or more SLIV group sets, each of the one or more SLIV group sets comprises at least one SLIV group; and at most a third number of data is received for each of the one or more SLIV group sets; and the method further comprising transmitting, by the wireless communication device to the network, feedback information for each of the one or more SLIV group sets, the feedback information comprising the third number of bits; or
the one or more SLIV groups comprises one or more SLIV group sets, each of the one or more SLIV group sets comprises multiplexed data; and the method further comprising transmitting, by the wireless communication device to the network, first feedback information corresponding to the multiplexed data in each of the one or more SLIV group sets, wherein the first feedback information is added at an end of second feedback information corresponding to each of the one or more SLIV group sets; or
the one or more SLIV groups comprises one or more SLIV group sets, each of the one or more SLIV group sets comprises multiplexed data; and the method further comprising transmitting, by the wireless communication device to the network, first feedback information corresponding to the multiplexed data in the one or more SLIV group sets, wherein the first feedback information is added at an end of second feedback information corresponding to the one or more SLIV groups or a time-domain resource; or
the one or more SLIV groups comprises one or more SLIV group sets, each of the one or more SLIV group sets comprises multiplexed data; and the method further comprising transmitting, by the wireless communication device to the network, first feedback information corresponding to the multiplexed data in the one or more SLIV group sets, wherein the first feedback information is added at an end of second feedback information corresponding to a codebook; or
the first number is 1; and the method further comprising: receiving, by the wireless communication device from the network, a second number of multiplexed data for each time-domain resource, wherein the second number is 1; and transmitting, by the wireless communication device to the network, feedback information for the second number of multiplexed data, the feedback information comprises 1 bit; or
the first number is 1; and the method further comprising: receiving, by the wireless communication device from the network, a second number of multiplexed data for each time-domain resource, wherein the second number is greater than 1; and transmitting, by the wireless communication device to the network, feedback information for the second number of multiplexed data, the feedback information comprises the second number of bits.

20-25. (canceled)

26. The method of claim 15, further comprising:
receiving, by the wireless communication device from the network, a Downlink Control Information (DCI) scheduling one or more of the-a plurality of PDSCHs that is multiplexed, the DCI comprises an indication of an order of feedback information, the indication is in a Downlink Assignment Index (DAI) field; and
transmitting, by the wireless communication device to the network according to the order, feedback information for the plurality of PDSCHs that is multiplexed and at least one normal PDSCH.

27. The method of claim 1, further comprising:
selecting, by the wireless communication device, two Physical Downlink Shared Channels (PDSCHs) with lowest configured index;
selecting, by the wireless communication device, at least one PDSCH other than the two PDSCHs according to a relationship of the two PDSCHs, wherein the relationship comprises one of Frequency-Domain Multiplexing (FDM) or Time-Domain multiplexing (TDM); and
receiving, by the wireless communication device, the two PDSCHs and the at least one PDSCH.

28. A wireless communication apparatus comprising at least one processor and a memory, wherein the at least one processor is configured to read code from the memory and implement operations of:
determining, by a wireless communication device, a time-domain resource of a first resource for transmitting or receiving first data overlaps with a time-domain resource of a second resource scheduled for transmitting or receiving second data; and
transmitting or receiving, by the wireless communication device to or from a network, both the first data and the second data.

29. A computer program product comprising a computer-readable program medium code stored thereupon, the code, when executed by at least one processor, causing the at least one processor to implement operations of:
determining, by a wireless communication device, a time-domain resource of a first resource for transmitting or receiving first data overlaps with a time-domain resource of a second resource scheduled for transmitting or receiving second data; and
transmitting or receiving, by the wireless communication device to or from a network, both the first data and the second data.
